(19) United States
(12) Patent Application Publication
(10) Pub. No.: US 2007/0153923 A1
(43) Pub. Date: Jul. 5, 2007

(54) Method and apparatus for providing a link adaptation scheme for a wireless communication system

(76) Inventors: Zhouyue Pi, San Diego, CA (US); Balaji Raghothaman, San Diego, CA (US)

Correspondence Address: DITTHAVONG MORI & STEINER, P.C., 918 Prince St., Alexandria, VA, 22314, US

(21) Appl. No.: 11/442,686

(22) Filed: May 26, 2006

Related U.S. Application Data
(60) Provisional application No. 60/755,727, filed on Dec. 30, 2005.

(51) Int. Cl. H04K 1/10

(52) U.S. Cl. 375/260

(57) ABSTRACT

An approach is provided for error correction in a multi-carrier wireless network or an Orthogonal Frequency Division Multiplexing (OFDM) network. A first rate is assigned to a first error correction channel. A second rate is assigned to a second error correction channel, wherein the first rate is different from the second rate.

### RELATED APPLICATIONS

This application claims the benefit of the earlier filing date under 35 U.S.C. §119(e) of U.S. Provisional Application Ser. No. 60/755,727 filed Dec. 30, 2005, entitled “Method and Apparatus for Providing a Link Adaptation Scheme for a Wireless Communication System,” the entirety of which is incorporated by reference.

### FIELD OF THE INVENTION

Various exemplary embodiments of the invention relate generally to communications.

### BACKGROUND OF THE INVENTION

Radio communication systems, such as cellular systems (e.g., spread spectrum systems (such as Code Division Multiple Access (CDMA) networks), or Time Division Multiple Access (TDMA) networks), provide users with the convenience of mobility along with a rich set of services and features. This convenience has spawned significant adoption by an ever growing number of consumers as an accepted mode of communication for business and personal uses in terms of communicating voice and data (including textual and graphical information). Because of the variety in the types of subscribers and their communication needs, service providers have concentrated on offering services that reflect differing levels of Quality of Service (QoS). For example, for personal use, a subscriber may be amenable to a lower QoS level (e.g., relatively higher delay, lower data rate, or lower availability) as trade off for lower fees. On the other hand, a business subscriber is likely to require a higher QoS level, as minimal delay, high speed and high availability are of primary import versus cost. Hence, as wireless communication technology continues to evolve, support for applications with different QoS requirements is imperative. This places a premium on efficient management of network capacity.

It is recognized that transmission errors impose a significant cost on capacity, as corrupted packets can require retransmitting the packets, thereby consuming additional bandwidth without increasing effective throughput. Therefore, error correction mechanisms play an important role in ensuring high throughput and efficient bandwidth utilization.

Conventional approaches to error correction are inflexible in that they cannot accommodate the different Packet Error Rate (PER) and delay requirements of different applications. These approaches also require significant overhead to operate, thereby undermining any benefits from their use.

Therefore, there is a need for an approach to provide an efficient error correction scheme that can support QoS requirements while minimizing overhead.

### SUMMARY OF SOME EXEMPLARY EMBODIMENTS

These and other needs are addressed by the invention, in which an approach is presented for providing an error correction scheme that utilizes multi-rate channels.

According to one aspect of an embodiment of the invention, a method comprises assigning a first rate to a first error correction channel: The method also comprises assigning a second rate to a second error correction channel, wherein the first rate is different from the second rate.

According to another aspect of an embodiment of the invention, an apparatus comprises a processor configured to assign a first rate to a first error correction channel, and to assign a second rate to a second error correction channel. The first rate is different from the second rate.

According to another aspect of an embodiment of the invention, a method comprises transmitting a packet over a first error correction channel of a first rate. The method also comprises transmitting another packet over a second error correction channel of a second rate, wherein the first rate is different from the second rate.

According to another aspect of an embodiment of the invention, an apparatus comprises a transceiver configured to transmit a packet over a first error correction channel of a first rate, and to transmit another packet over a second error correction channel of a second rate. The first rate is different from the second rate.

According to another aspect of an embodiment of the invention, a system comprises a base station configured to assign different rates to a plurality of synchronous error correction channels. The system also comprises a terminal configured to transmit a packet over one of the synchronous error correction channels.

According to yet another aspect of an embodiment of the invention, a system comprises a terminal configured to assign different rates to a plurality of synchronous error correction channels. The system also comprises a base station configured to transmit a packet over one of the synchronous error correction channels.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The invention is illustrated by way of example, and not by way of limitation, in the figures of the accompanying drawings in which like reference numerals refer to similar elements and in which:

FIG. 1 is a diagram of the architecture of a wireless system capable of utilizing a multi-rate N-channel error correction mechanism, in accordance with various embodiments of the invention;

FIGS. 2A and 2B are flowcharts of processes relating to a multi-rate N-channel error correction mechanism, in accordance with various embodiments of the invention;

FIG. 3 is a diagram of a conventional N-channel synchronous Hybrid Automatic Repeat Request (HARQ) scheme;

FIG. 4 is a diagram of a conventional Asynchronous Adaptive Incremental Redundancy (AAIR) scheme;

FIGS. 5A and 5B are diagrams of multi-rate N-channel HARQ schemes, in accordance with various embodiments of the invention;

FIG. 6 is a diagram of hardware that can be used to implement various embodiments of the invention;

FIGS. 7A and 7B are diagrams of different cellular mobile phone systems capable of supporting various embodiments of the invention;

FIG. 8 is a diagram of exemplary components of a mobile station capable of operating in the systems of FIGS. 7A and 7B, according to an embodiment of the invention; and

FIG. 9 is a diagram of an enterprise network capable of supporting the processes described herein, according to an embodiment of the invention.

### DESCRIPTION OF THE PREFERRED EMBODIMENT

An apparatus, method, and software for providing a multi-rate N-channel error correction mechanism are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although the embodiments of the invention are discussed with respect to a packet data network and a Hybrid Automatic Repeat Request (HARQ) scheme, it is recognized by one of ordinary skill in the art that the embodiments of the inventions have applicability to any type of communication system (e.g., wireless networks, wired networks, etc.) and other equivalent error correction and/or rate adaptation mechanisms.

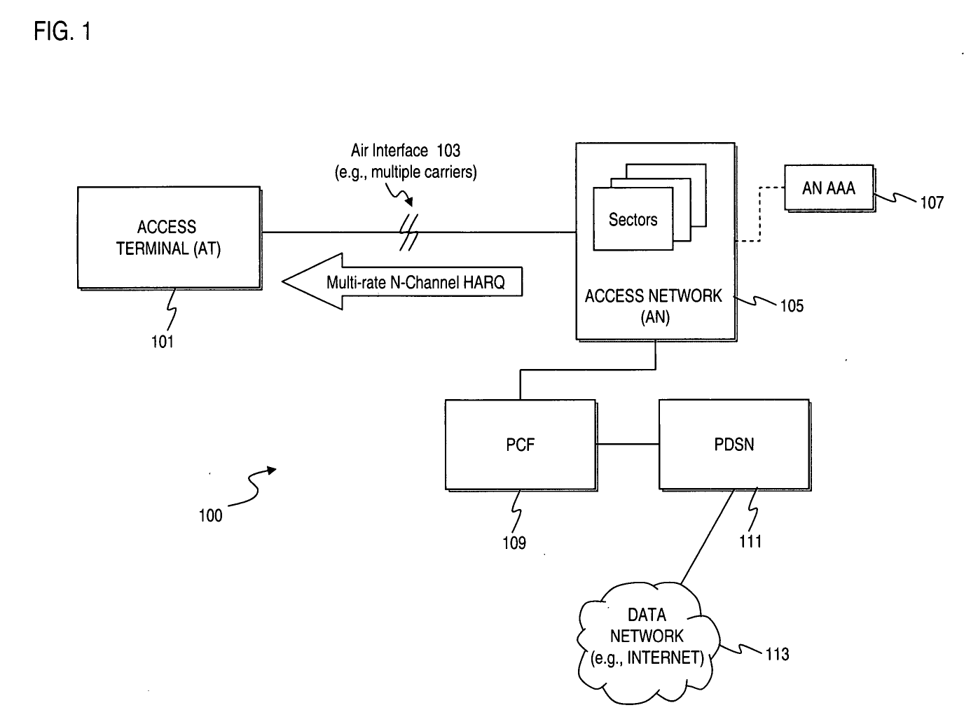

FIG. 1 is a diagram of the architecture of a wireless system capable of utilizing a multi-rate N-channel error correction mechanism, in accordance with various embodiments of the invention. By way of example, the error correction mechanism described herein is a Hybrid Automatic Repeat Request (HARQ) scheme. Hybrid ARQ (HARQ) provides a link adaptation mechanism, and is a combination of ARQ and Forward Error Correction (FEC) techniques. The erroneous packets are used in conjunction with retransmitted packets. The radio network 100 includes one or more access terminals (ATs) 101 of which one AT 101 is shown in communication with an access network (AN) 105 over an air interface 103. The HARQ scheme permits the receiver, e.g., AT 101, to indicate to the transmitter (e.g., AN 105) that a packet or sub-packet has been received incorrectly, and thus, requests the AN 105 to resend the particular packet(s). This can be accomplished with a stop-and-wait (SAW) procedure, in which the AN 105 waits for a response from the AT 101 before sending or resending packets.

The system 100, according to one embodiment, provides Third Generation Partnership Project 2 (3GPP2) cdma2000 High Rate Packet Data Revision C (also known as cdma2000 Evolution Phase 2, DO Revision C) networks. In another embodiment, the system 100 also supports 3GPP Long Term Evolution (LTE) systems. In cdma2000 systems, the AT 101 is equivalent to a mobile station, and the access network 105 is equivalent to a base station.

The AT 101 is a device that provides data connectivity to a user. For example, the AT 101 can be connected to a computing system, such as a personal computer, a personal digital assistant, and etc. or a data service enabled cellular handset. The radio configuration encompasses two modes of operations: 1× and multi-carrier (i.e., N×, where N is an integer). Multi-carrier systems employ multiple 1× carriers to increase the data rate to the AT 101 (or mobile station) over the forward link. Hence, unlike 1× technology, the multi-carrier system operates over multiple carriers. In other words, the AT 101 is able to access multiple carriers simultaneously. Additionally, the reverse link can utilize multiple carriers.

The AN 105 is a network equipment that provides data connectivity between a packet switched data network, such as the global Internet 113 and the AT 101. The AN 105 communicates with a Packet Data Service Node (PDSN) 111 via a Packet Control Function (PCF) 109. Either the AN 105 or the PCF 109 provides a SC/MM (Session Control and Mobility Management) function, which among other functions includes storing of HRPD session related information, performing the terminal authentication procedure to determine whether an AT 101 should be authenticated when the AT 101 is accessing the radio network, and managing the location of the AT 101. The PCF 109 is further described in 3GPP2 A.S0001-A v2.0, entitled “3GPP2 Access Network Interfaces Interoperability Specification,” June 2001, which is incorporated herein by reference in its entirety.

In addition, the AN 105 communicates with an AN-AAA (Authentication, Authorization and Accounting entity) 107, which provides terminal authentication and authorization functions for the AN 105.

Both the cdma2000 1×EV-DV (Evolution-Data and Voice) and 1×EV-DO (Evolution-Data Optimized) air interface standards specify a packet data channel for use in transporting packets of data over the air interface on the forward link and the reverse link. The wireless communication system 100 may be designed to provide various types of services. These services may include point-to-point services, or dedicated services such as voice and packet data, whereby data is transmitted from a transmission source (e.g., a base station) to a specific recipient terminal. Such services may also include point-to-multipoint (i.e., multicast) services, or broadcast services, whereby data is transmitted from a transmission source to a number of recipient terminals (e.g., AT 101).

In the multiple-access wireless communication system 100, communications between users are conducted through one or more AT(s) 101 and a user (access terminal) on one wireless station communicates to a second user on a second wireless station by conveying information signal on a reverse link to a base station. The AN 105 receives the information signal and conveys the information signal on a forward link to the AT station 101. The AN 105 then conveys the information signal on a forward link to the station 101. The forward link refers to transmissions from an AN 105 to a wireless station 101, and the reverse link refers to transmissions from the station 101 to the AN 105. The AN 105 receives the data from the first user on the wireless station on a reverse link, and routes the data through a public switched telephone network (PSTN) to the second user on a landline station. In many communication systems, e.g., IS-95, Wideband CDMA (WCDMA), and IS-2000, the forward link and the reverse link are allocated separate frequencies.

The AN 105, in an exemplary embodiment, includes a High Rate Packet Data (HRPD) base station to support high data rate services. It should be understood that the base station provides the radio frequency (RF) interface (carrier(s)) between an access terminal and the network via one or more transceivers. The HRPD base station provides a separate data only (DO) carrier for HRPD applications for each sector (or cell) served by the HRPD base station. A separate base station or carrier (not shown) provides the voice carrier(s) for voice applications. A HRPD access terminal may be a DO access terminal or a dual mode mobile terminal capable of utilizing both voice services and data services. To engage in a data session, the KRPD access terminal connects to a DO carrier to use the DO high-speed data service. The data session is controlled by a Packet Data Service Node (PDSN) 111, which routes all data packets between the HRPD access terminal and the Internet. The PDSN 111 has a direct connection to the Packet Control Function (PCF) 109, which interfaces with a Base Station Controller (BSC) of the HRPD base station. The BSC is responsible for operation, maintenance and administration of the HRPD base station, speech coding, rate adaptation and handling of the radio resources. It should be understood that the BSC may be a separate node or may be co-located with one or more HRPD base stations.

In a 1× carrier, each HRPD base station can serve multiple (e.g., three) sectors (or cells). However, it should be understood that each HRPD base station may generally serve only a single cell (referred to as an omni cell). It should also be understood that the network 100 may include multiple HRPD base stations, each serving one or more sectors, with HRPD mobile terminals being capable of handing off between sectors of the same HRPD base station or sectors of different HRPD base stations. For each sector (or cell), the HRPD base station further employs a single shared, time division multiplexed (TDM) forward link, where one single HRPD mobile terminal can be served by single user packets and multiple mobile terminals can be served by multi-user packets at any instance. The forward link throughput rate is shared by all HRPD mobile terminals. A HRPD access terminal selects a serving sector (or cell) of the HRPD base station by pointing its Data Rate Control (DRC) towards the sector and requesting a forward data rate according to the channel conditions (i.e., based on the Carrier to Interference (C/I) ratio of the channel).

Wireless communication technologies continue to evolve to provide higher data rate and better quality of service for a variety of applications with distinct characteristics. The cdma2000 High Rate Packet Data (HRPD) standard provides high data rate over a 1.25 MHz carrier frequency. This system provides Data Only (DO) service in one 1.25 MHz carrier (1×), which sometimes is referred to as 1×DO system. To further improve the service provisioning, this cdma2000 HRPD standard needs to account for multi-carrier CDMA systems. In this system (referred to as multi-carrier HRPD (MC-HRPD) system, or N×DO system), the access terminal (AT) can transmit and/or receive data streams in multiple 1.25 MHz bands. Further evolution of cdma2000 HRPD systems employ advanced communication technologies such as Orthogonal Frequency Division Multiplexing (OFDM), Multiple-Input-Multiple-Output (MIMO) technologies, Spatial Division Multiple Access (SDMA), and interference cancellation. These systems can operate in 1.25 MHz˜20 MHz spectrum.

One approach for accommodating a multitude of ATs in a multi-carrier operation is explained in 3GPP2 contribution, C25-20050620-030, entitled “Increased Forward Link MAC Indices For Multi-Carrier Operation,” Jun. 20, 2005 (which is incorporated herein by reference in its entirety).

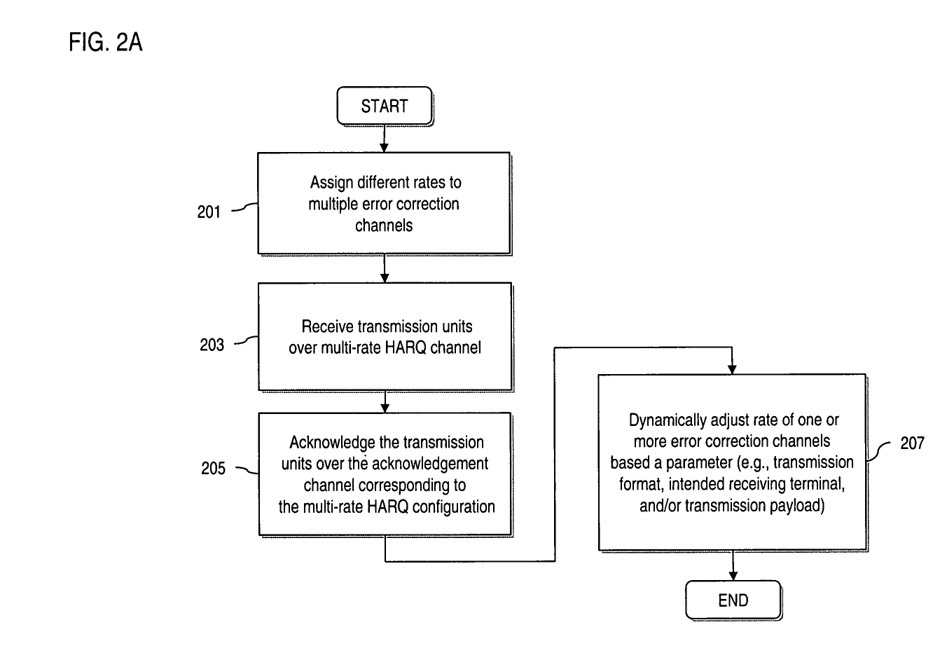

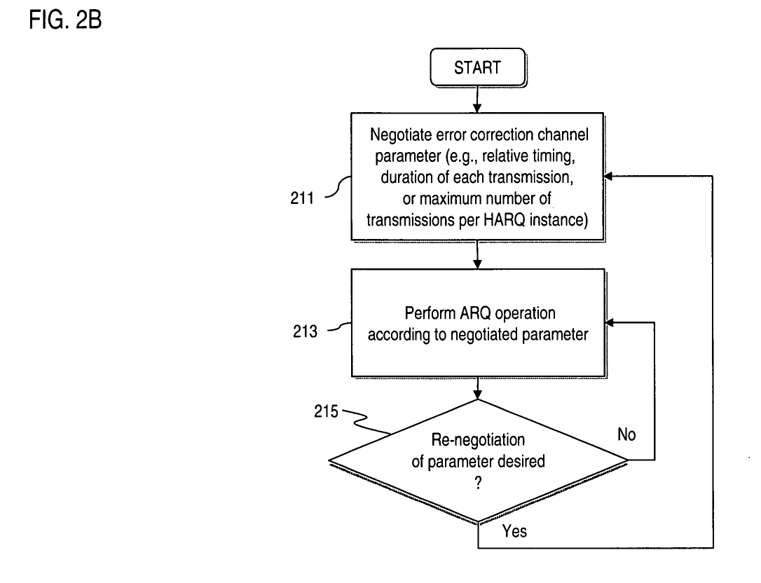

FIGS. 2A and 2B are flowcharts of processes relating to a multi-rate N-channel error correction mechanism, in accordance with various embodiments of the invention. The system 101 utilizes multiple error correction channels—e.g., HARQ channels. According to the various embodiments, these channels are synchronous. As seen in FIG. 2A, the multiple channels are assigned different rates, per step 201, such that one channel has one particular rate, and another channel is designated with another rate. In other words, the time interval between retransmissions can vary from one channel to another channel, but within the particular channels (i.e., HARQ instances) the time interval between transmissions is constant to maintain the synchronous characteristic of the communication.

In this example, the assignment of the error correction channels is performed at the AT 101; however, it is contemplated that the assignment can also be performed at the AN 105. Per step 203, packets (or sub-packets) are received at the AT 101 over a HARQ channel from the AN 105. The AT 101 provides acknowledgement signaling over an appropriate acknowledgement channel corresponding to the multi-rate HARQ configuration—e.g., HARQ channel parameters (step 205). The acknowledgement signaling can include ACK (acknowledgement) and/or NACK (negative acknowledgement) messages.

In step 207, any one of the rates of the channels can be dynamically adjusted based on a variety of parameters. For instance, the rate of the error correction channel, e.g., HARQ channel, can be changed based on transmission format of the packet, the intended receiving node, and/or transmission payload. The rate of the HARQ channel, in one embodiment, can be part of the transmission format information; for example, the transmission format can be specified by a n-tuple (n being any integer) of encoder packet size, number of slots, and other parameters. The rate of the HARQ instance can be added as another entry into the transmission format. Moreover, the rate of the HARQ channel can be changed per HARQ instance.

Further, the error correction mechanism in this example provides a capability to negotiate error correction parameters, as shown in FIG. 2B. Accordingly, the AT 101 and the AN 105 can negotiate, for example, relative timing of the acknowledgment signaling messages, duration of each transmission unit, and maximum number of transmission units per HARQ instance, as in step 211. Upon completion of the negotiation, in step 213, the AT 101 communicates using the negotiated parameters; such communication can be referred to as performing ARQ operations, for instance. Subsequent to this communication, the AT 101 and the AN 105 can renegotiate these parameters (as determined by step 215 whether such renegotiation is desirable). The modification of the error correction parameters can proceed as before, according to steps 211 and 213.

Thus, the relative timing, the duration of each transmission, and the maximum number of transmissions per HARQ instance can be configured and negotiated at the beginning of the communication, and can be re-configured and re-negotiated at any point during the communication. The configuration and re-configuration can be communicated via, for example, signaling messages.

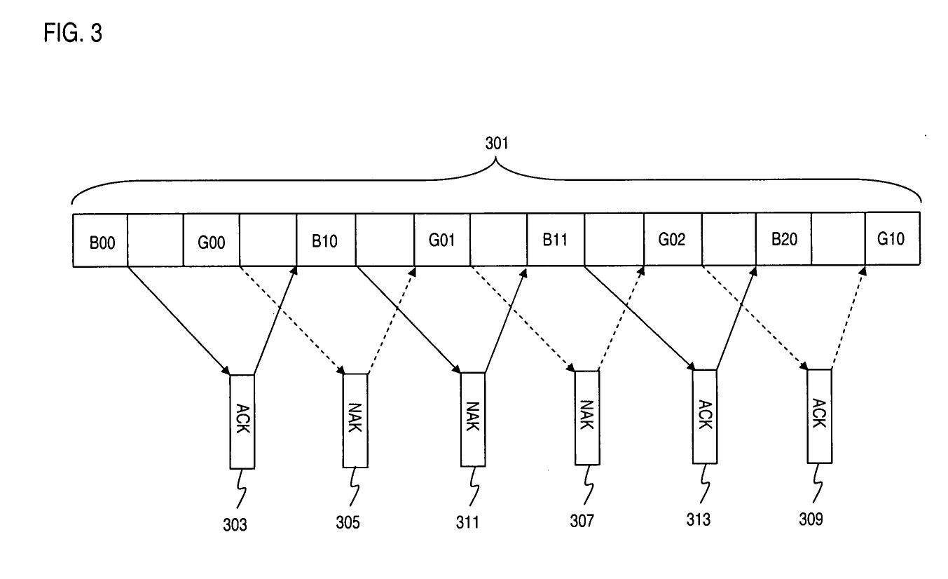

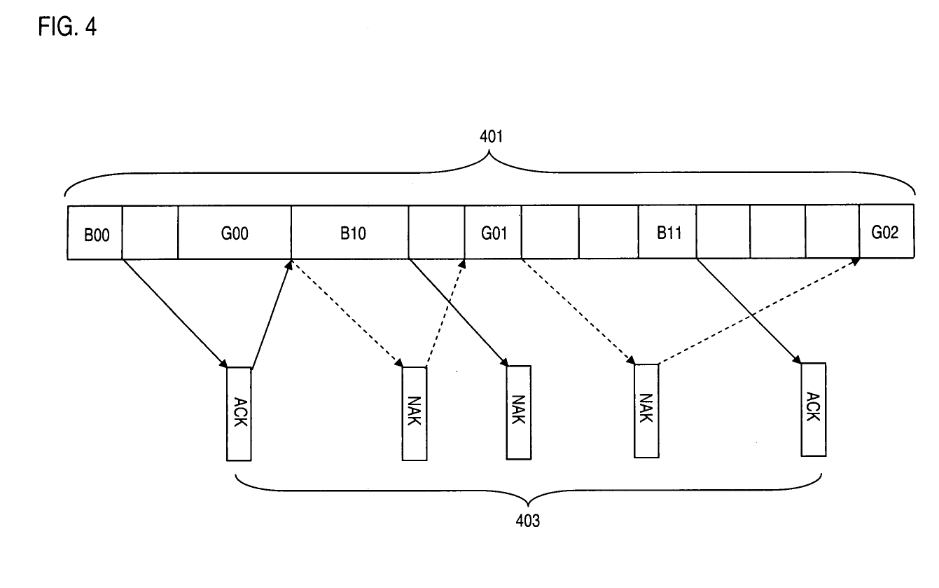

To better appreciate the above multi-rate N-channel error correction mechanism, it is instructive to examine the conventional error correction approaches of FIGS. 3 and 4.

FIGS. 3 and 4 are diagrams of conventional error correction schemes of, respectively, N-channel synchronous Hybrid Automatic Repeat Request (HARQ), and Asynchronous Adaptive Incremental Redundancy (AAIR). The conventional techniques (as shown in FIGS. 3 and 4) include, for example, a synchronous 4-channel HARQ mechanism, and an Asynchronous Adaptive Incremental Redundancy (AAIR). Synchronous 4-channel HARQ mechanism has been adopted in cdma2000 High Rate Packet Data (HRPD), while AAIR has been adopted in cdma2000 Rev. D (EV-DV). These techniques, however, possess respective drawbacks. One drawback with N-channel synchronous HARQ is that the scheme is not flexible. For example, the scheme cannot readily adapt to different QoS levels. The AAIR, and other asynchronous ARQ mechanisms in general, require substantial overhead to operate, effectively negating the benefits of implementing such mechanisms.

As seen in FIG. 3, in N-channel synchronous HARQ, the entire transmission duty cycle of the data stream 301 is divided into N interlaces (N being any integer). For purposes of illustration, two channels (named B channel and G channel) are represented with ‘B’ and ‘G’ prefixes. A transmission is denoted as ‘Xyz’, where ‘X’ represents the HARQ channel ID (identification), ‘y’ represents the packet ID on that HARQ channel, and ‘z’ represents the sub-packet ID of the packet in transmission. For example, ‘B00’ indicates that the first sub-packet of the first packet transmitted on the ‘B’ HARQ channel. Within each HARQ channel, the basic ARQ mechanism is stop-and-wait. In this example, an ACK message 303 is sent over the ‘B’ HARQ channel by the receiver (e.g., AT 101) upon receipt of the B00 sub-packet. Independently, the ‘G’ HARQ channel is used to transmit a NACK message 305 to notify the transmitter (e.g., AN 105) that the G00 sub-packet has not been received. The G01 sub-packet also was not received, resulting in transmission of a NAK message 307 by the AT 101 over the ‘G’ HARQ channel. However, the transmission of G02 was successful; consequently, the AT 101 sends an ACK message 309 to the AN 101 indicating so. With respect to the ‘B’ HARQ channel, the B10 sub-packet was not received, whereby a NAK message 311 is sent to the AN 105. The B11 sub-packet results in an ACK message 313 being transmitted to acknowledge successful delivery of the sub-packet. By using multiple channels, full duty cycle can be achieved. That is, transmission can occur on other HARQ channels while one channel is waiting for acknowledgements from the AT 101. However, this approach fails to recognize that need to more flexibly adapt to different applications associated with potentially different service level rates.

With Adaptive Asynchronous Incremental Redundancy, there are also multiple HARQ channels. In this case, FIG. 4 shows channels ‘B’ and ‘G’ in the example of FIG. 3. Unlike synchronous HARQ, the relative timing of the HARQ channels are not fixed. The duration of each transmission may also vary in order to adapt to the channel conditions. Hence, the AAIR operation employs sub-packets within data stream 401 of varying transmission durations. Consequently, the signaling messages 403 can arrive at the AN 101 at different times. As noted, this approach requires significant overhead, in part, to accommodate the asynchronous nature of the transmissions.

By contrast, the multi-rate N-channel error correction mechanism of FIGS. SA and SB overcome the drawbacks of the schemes of FIGS. 3 and 4. The operation of this multi-rate N-channel error correction mechanism is detailed below.

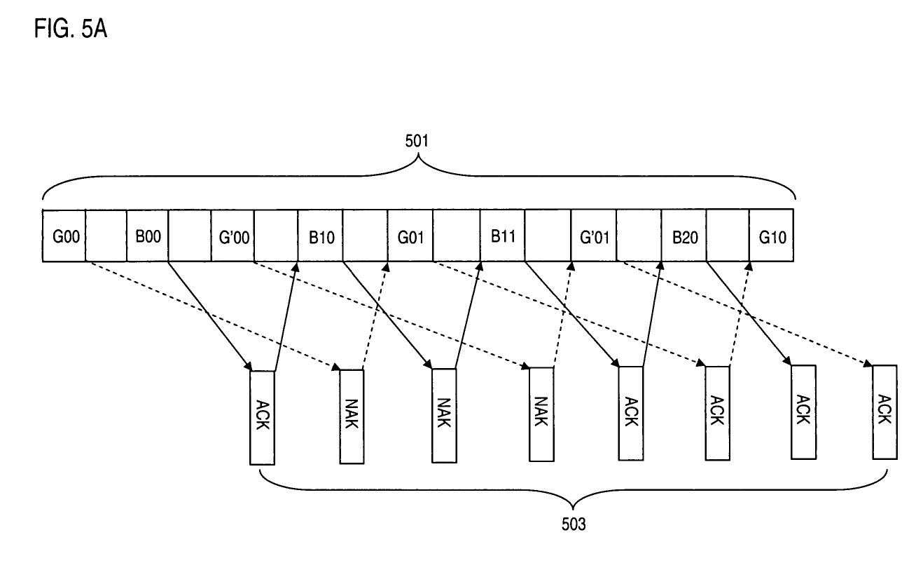

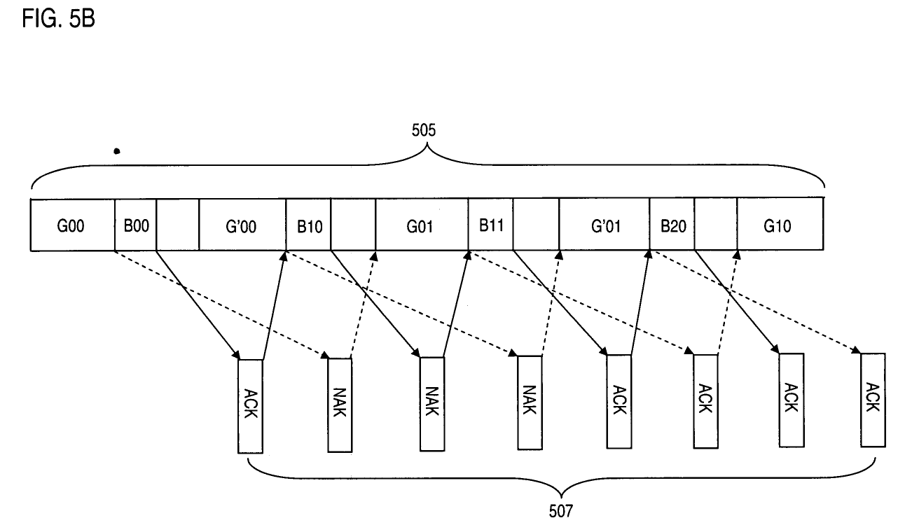

FIGS. 5A and SB are diagrams of multi-rate N-channel HARQ schemes, in accordance with various embodiments of the invention. With this scheme, the HARQ channels can have different rates. In other words, the time interval between retransmissions can be different for different HARQ channels. However, these HARQ channels are still synchronous in nature; i.e., the time interval between transmissions is kept constant for one HARQ instance, so that the overhead can be minimized. The multi-rate N-channel HARQ scheme has comparable complexity and overhead as a single rate N-channel HARQ, but more flexibility in accommodating different delay and throughput requirements.

In an exemplary embodiment, all transmission units (shown in FIG. 5A) have the same duration within the data stream 501; these transmission units can be referred to as sub-packets. This duration can be a slot—e.g., the basic unit in physical layer transmission. It is noted that this duration can be a fraction of a slot or multiple slots. As seen in FIG. 5A, the timing of the multiple HARQ channels is fixed. For explanatory purposes, three HARQ channels are shown: ‘B’ channel (‘Bxx’); ‘G’ channel (‘Gxx’) channel, and the ‘G prime’ channel (‘G′xx’). In this example, the ‘B’ channel is used every 4 slots; the ‘G’ channel is used every 8slots; the ‘G prime’ channel is also used every 8 slots.

For example, in the forward link, the ‘G’ and ‘G prime’ channel can be used for transmissions to mobile stations (access terminals or devices) requiring high data rates. For those mobile stations, the fading is often too fast for a scheduler to take advantage of favorable channel conditions. Thus, it may be necessary to increase the time interval between retransmissions to realize more time diversity. In addition, the lower rate HARQ channels can be used to accommodate low cost receivers because the larger time interval between retransmissions allows more time for the receiver (e.g., AT 101) to decode the packet before send back the acknowledgement.

On the other hand, the ‘B’ channel can be used for transmissions to low speed mobiles. For these mobile stations, the channel conditions generally change slowly. Thus, it is possible for the scheduler to obtain accurate channel state information and to adapt the transmission rate. In this case, it is more advantageous to reduce the time interval between retransmissions so that the channel condition does not change much, as to render the rate adaptation inaccurate.

The HARQ channels with different rates can also be used to support applications with different quality of service requirements (e.g., QoS levels, service level agreements (SLAs), etc.). For example, an HARQ channel with higher rate may be used to support delay-sensitive applications such as packetized voice applications, including such telephony services as Voice over IP (Internet Protocol), while an HARQ channel with lower rate can be used to support best effort traffic.

The acknowledgement signaling messages 503 corresponding to the respective HARQ channels are transmitted at fixed time intervals with respect to the particular channels.

FIG. 5B illustrates another embodiment of multi-rate N-channel HARQ. In this exemplary embodiment, the sub-packets may have different durations. As shown, by way of example, sub-packet ‘G00’ within the data stream 505 is transmitted in two slots, while sub-packet ‘B00’ is transmitted in one slot. However, the relative timing of the ‘G’ channel and the ‘B’ channel is fixed.

In addition to (or in lieu of) the above embodiments, it is contemplated that the multi-rate N-channel error correction mechanism can be implemented in many other forms. Although two different rates are illustrated in the above exemplary embodiments, the multi-rate N-channel error correction mechanism has applicability to other scenarios involving more than two rates, and more than two transmission durations. Also, the timing of the acknowledgements needs not to be fixed as shown in FIGS. 5A and 5B.

The described multi-rate HARQ channels (which provide different time intervals between transmissions) possess a number of advantages. For instance, the arrangement of FIGS. 5A and 5B provide great flexibility for accommodating various channel conditions and different applications. Additionally, under this approach, more efficient utilization of radio resources can be achieved.

One of ordinary skill in the art would recognize that the processes for providing a multi-rate N-channel error correction mechanism may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below.

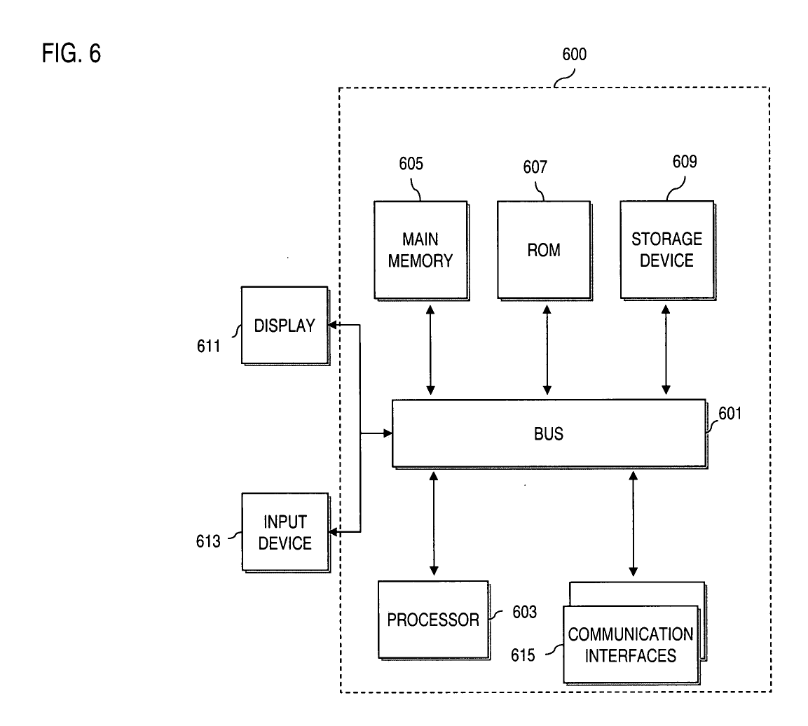

FIG. 6 illustrates exemplary hardware upon which various embodiments of the invention can be implemented. A computing system 600 includes a bus 601 or other communication mechanism for communicating information and a processor 603 coupled to the bus 601 for processing information. The computing system 600 also includes main memory 605, such as a random access memory (RAM) or other dynamic storage device, coupled to the bus 601 for storing information and instructions to be executed by the processor 603. Main memory 605 can also be used for storing temporary variables or other intermediate information during execution of instructions by the processor 603. The computing system 600 may further include a read only memory (ROM) 607 or other static storage device coupled to the bus 601 for storing static information and instructions for the processor 603. A storage device 609, such as a magnetic disk or optical disk, is coupled to the bus 601 for persistently storing information and instructions.

The computing system 600 may be coupled via the bus 601 to a display 611, such as a liquid crystal display, or active matrix display, for displaying information to a user. An input device 613, such as a keyboard including alphanumeric and other keys, may be coupled to the bus 601 for communicating information and command selections to the processor 603. The input device 613 can include a cursor control, such as a mouse, a trackball, or cursor direction keys, for communicating direction information and command selections to the processor 603 and for controlling cursor movement on the display 611.

According to various embodiments of the invention, the processes described herein can be provided by the computing system 600 in response to the processor 603 executing an arrangement of instructions contained in main memory 605. Such instructions can be read into main memory 605 from another computer-readable medium, such as the storage device 609. Execution of the arrangement of instructions contained in main memory 605 causes the processor 603 to perform the process steps described herein. One or more processors in a multi-processing arrangement may also be employed to execute the instructions contained in main memory 605. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 600 also includes at least one communication interface 615 coupled to bus 601. The communication interface 615 provides a two-way data communication coupling to a network link (not shown). The communication interface 615 sends and receives electrical, electromagnetic, or optical signals that carry digital data streams representing various types of information. Further, the communication interface 615 can include peripheral interface devices, such as a Universal Serial Bus (USB) interface, a PCMCIA (Personal Computer Memory Card International Association) interface, etc.

The processor 603 may execute the transmitted code while being received and/or store the code in the storage device 609, or other non-volatile storage for later execution. In this manner, the computing system 600 may obtain application code in the form of a carrier wave.

The term “computer-readable medium” as used herein refers to any medium that participates in providing instructions to the processor 603 for execution. Such a medium may take many forms, including but not limited to non-volatile media, volatile media, and transmission media. Non-volatile media include, for example, optical or magnetic disks, such as the storage device 609. Volatile media include dynamic memory, such as main memory 605. Transmission media include coaxial cables, copper wire and fiber optics, including the wires that comprise the bus 601. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

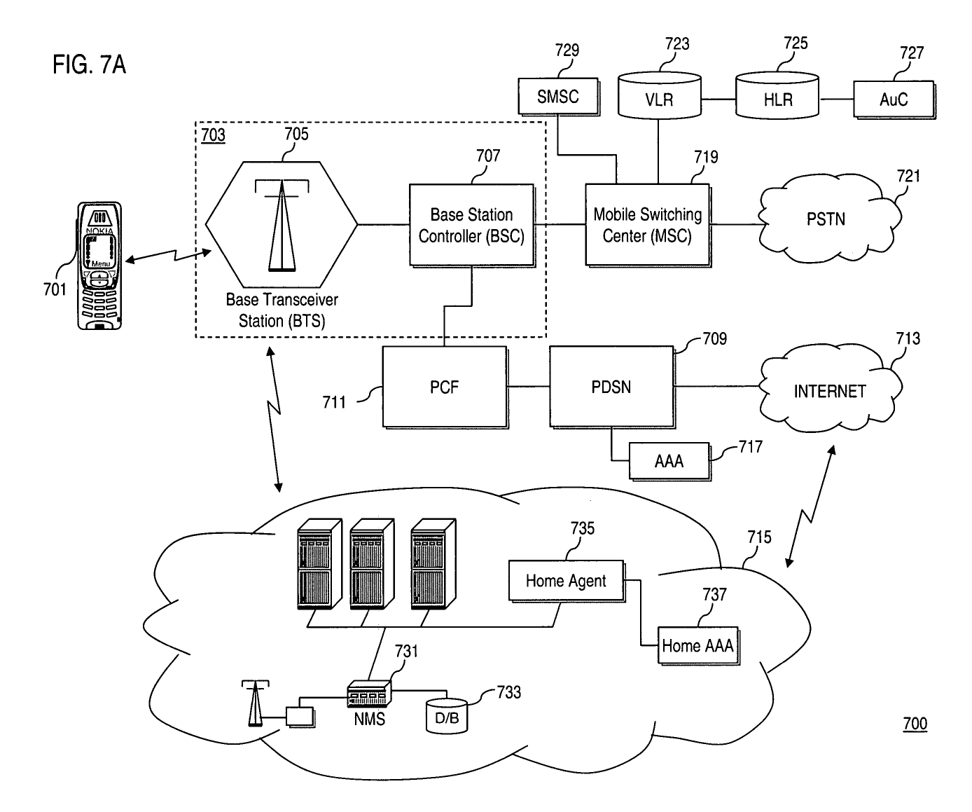

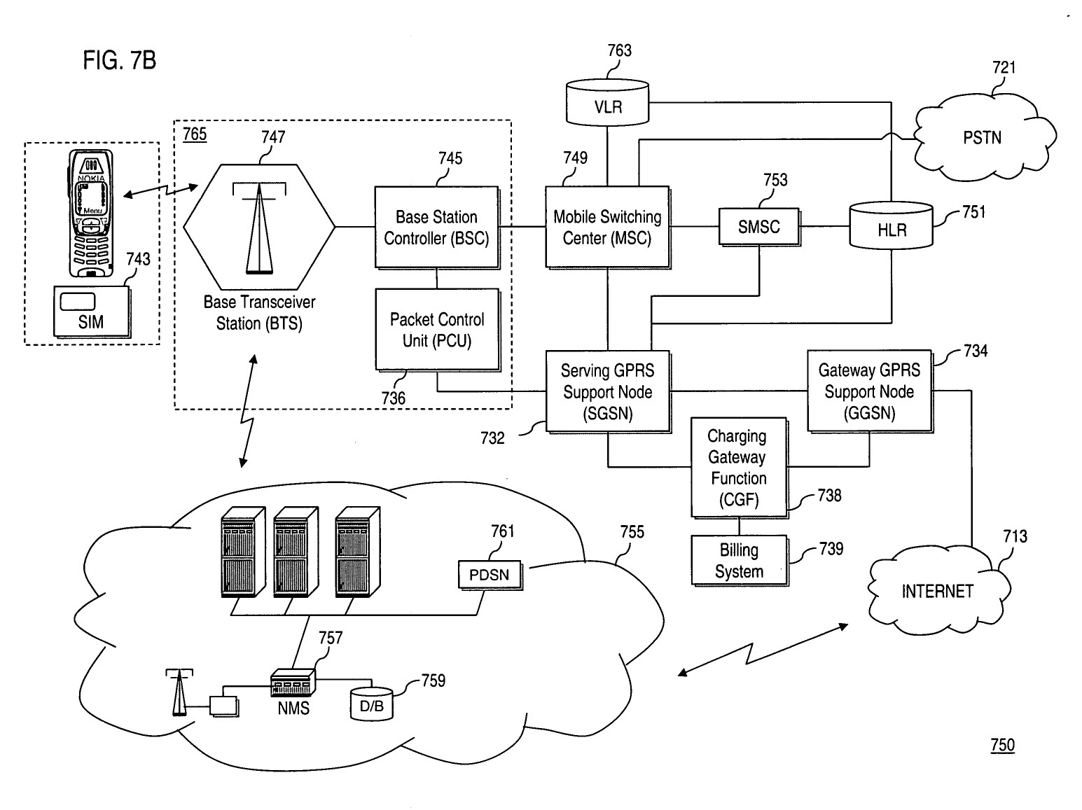

FIGS. 7A and 7B are diagrams of different cellular mobile phone systems capable of supporting various embodiments of the invention. FIGS. 7A and 7B show exemplary cellular mobile phone systems each with both mobile station (e.g., handset) and base station having a transceiver installed (as part of a Digital Signal Processor (DSP)), hardware, software, an integrated circuit, and/or a semiconductor device in the base station and mobile station). By way of example, the radio network supports Second and Third Generation (2G and 3G) services as defined by the International Telecommunications Union (ITU) for International Mobile Telecommunications 2000 (IMT-2000). For the purposes of explanation, the carrier and channel selection capability of the radio network is explained with respect to a cdma2000 architecture. As the third-generation version of IS-95, cdma2000 is being standardized in the Third Generation Partnership Project 2 (3GPP2).

A radio network 700 includes mobile stations 701 (e.g., handsets, terminals, stations, units, devices, or any type of interface to the user (such as “wearable” circuitry, etc.)) in communication with a Base Station Subsystem (BSS) 703. According to one embodiment of the invention, the radio network supports Third Generation (3G) services as defined by the International Telecommunications Union (ITU) for International Mobile Telecommunications 2000 (IMT-2000).

In this example, the BSS 703 includes a Base Transceiver Station (BTS) 705 and Base Station Controller (BSC) 707. Although a single BTS is shown, it is recognized that multiple BTSs are typically connected to the BSC through, for example, point-to-point links. Each BSS 703 is linked to a Packet Data Serving Node (PDSN) 709 through a transmission control entity, or a Packet Control Function (PCF) 711. Since the PDSN 709 serves as a gateway to external networks, e.g., the Internet 713 or other private consumer networks 715, the PDSN 709 can include an Access, Authorization and Accounting system (AAA) 717 to securely determine the identity and privileges of a user and to track each user's activities. The network 715 comprises a Network Management System (NMS) 731 linked to one or more databases 733 that are accessed through a Home Agent (HA) 735 secured by a Home AAA 737.

Although a single BSS 703 is shown, it is recognized that multiple BSSs 703 are typically connected to a Mobile Switching Center (MSC) 719. The MSC 719 provides connectivity to a circuit-switched telephone network, such as the Public Switched Telephone Network (PSTN) 721. Similarly, it is also recognized that the MSC 719 may be connected to other MSCs 719 on the same network 700 and/or to other radio networks. The MSC 719 is generally collocated with a Visitor Location Register (VLR) 723 database that holds temporary information about active subscribers to that MSC 719. The data within the VLR 723 database is to a large extent a copy of the Home Location Register (HLR) 725 database, which stores detailed subscriber service subscription information. In some implementations, the HLR 725 and VLR 723 are the same physical database; however, the HLR 725 can be located at a remote location accessed through, for example, a Signaling System Number 7 (SS7) network. An Authentication Center (AuC) 727 containing subscriber-specific authentication data, such as a secret authentication key, is associated with the HLR 725 for authenticating users. Furthermore, the MSC 719 is connected to a Short Message Service Center (SMSC) 729 that stores and forwards short messages to and from the radio network 700.

During typical operation of the cellular telephone system, BTSs 705 receive and demodulate sets of reverse-link signals from sets of mobile units 701 conducting telephone calls or other communications. Each reverse-link signal received by a given BTS 705 is processed within that station. The resulting data is forwarded to the BSC 707. The BSC 707 provides call resource allocation and mobility management functionality including the orchestration of soft handoffs between BTSs 705. The BSC 707 also routes the received data to the MSC 719, which in turn provides additional routing and/or switching for interface with the PSTN 721. The MSC 719 is also responsible for call setup, call termination, management of inter-MSC handover and supplementary services, and collecting, charging and accounting information. Similarly, the radio network 700 sends forward-link messages. The PSTN 721 interfaces with the MSC 719. The MSC 719 additionally interfaces with the BSC 707, which in turn communicates with the BTSs 705, which modulate and transmit sets of forward-link signals to the sets of mobile units 701.

As shown in FIG. 7B, the two key elements of the General Packet Radio Service (GPRS) infrastructure 750 are the Serving GPRS Supporting Node (SGSN) 732 and the Gateway GPRS Support Node (GGSN) 734. In addition, the GPRS infrastructure includes a Packet Control Unit PCU (1336) and a Charging Gateway Function (CGF) 738 linked to a Billing System 739. A GPRS the Mobile Station (MS) 741 employs a Subscriber Identity Module (SIM) 743.

The PCU 736 is a logical network element responsible for GPRS-related functions such as air interface access control, packet scheduling on the air interface, and packet assembly and re-assembly. Generally the PCU 736 is physically integrated with the BSC 745; however, it can be collocated with a BTS 747 or a SGSN 732. The SGSN 732 provides equivalent functions as the MSC 749 including mobility management, security, and access control functions but in the packet-switched domain. Furthermore, the SGSN 732 has connectivity with the PCU 736 through, for example, a Fame Relay-based interface using the BSS GPRS protocol (BSSGP). Although only one SGSN is shown, it is recognized that that multiple SGSNs 731 can be employed and can divide the service area into corresponding routing areas (RAs). A SGSN/SGSN interface allows packet tunneling from old SGSNs to new SGSNs when an RA update takes place during an ongoing Personal Development Planning (PDP) context. While a given SGSN may serve multiple BSCs 745, any given BSC 745 generally interfaces with one SGSN 732. Also, the SGSN 732 is optionally connected with the HLR 751 through an SS7-based interface using GPRS enhanced Mobile Application Part (MAP) or with the MSC 749 through an SS7-based interface using Signaling Connection Control Part (SCCP). The SGSN/ILR interface allows the SGSN 732 to provide location updates to the HLR 751 and to retrieve GPRS-related subscription information within the SGSN service area. The SGSN/MSC interface enables coordination between circuit-switched services and packet data services such as paging a subscriber for a voice call. Finally, the SGSN 732 interfaces with a SMSC 753 to enable short messaging functionality over the network 750.

The GGSN 734 is the gateway to external packet data networks, such as the Internet 713 or other private customer networks 755. The network 755 comprises a Network Management System (NMS) 757 linked to one or more databases 759 accessed through a PDSN 761. The GGSN 734 assigns Internet Protocol (EP) addresses and can also authenticate users acting as a Remote Authentication Dial-In User Service host. Firewalls located at the GGSN 734 also perform a firewall function to restrict unauthorized traffic. Although only one GGSN 734 is shown, it is recognized that a given SGSN 732 may interface with one or more GGSNs 733 to allow user data to be tunneled between the two entities as well as to and from the network 750. When external data networks initialize sessions over the GPRS network 750, the GGSN 734 queries the BLR 751 for the SGSN 732 currently serving a MS 741.

The BTS 747 and BSC 745 manage the radio interface, including controlling which Mobile Station (MS) 741 has access to the radio channel at what time. These elements essentially relay messages between the MS 741 and SGSN 732. The SGSN 732 manages communications with an MS 741, sending and receiving data and keeping track of its location. The SGSN 732 also registers the MS 741, authenticates the MS 741, and encrypts data sent to the MS 741.

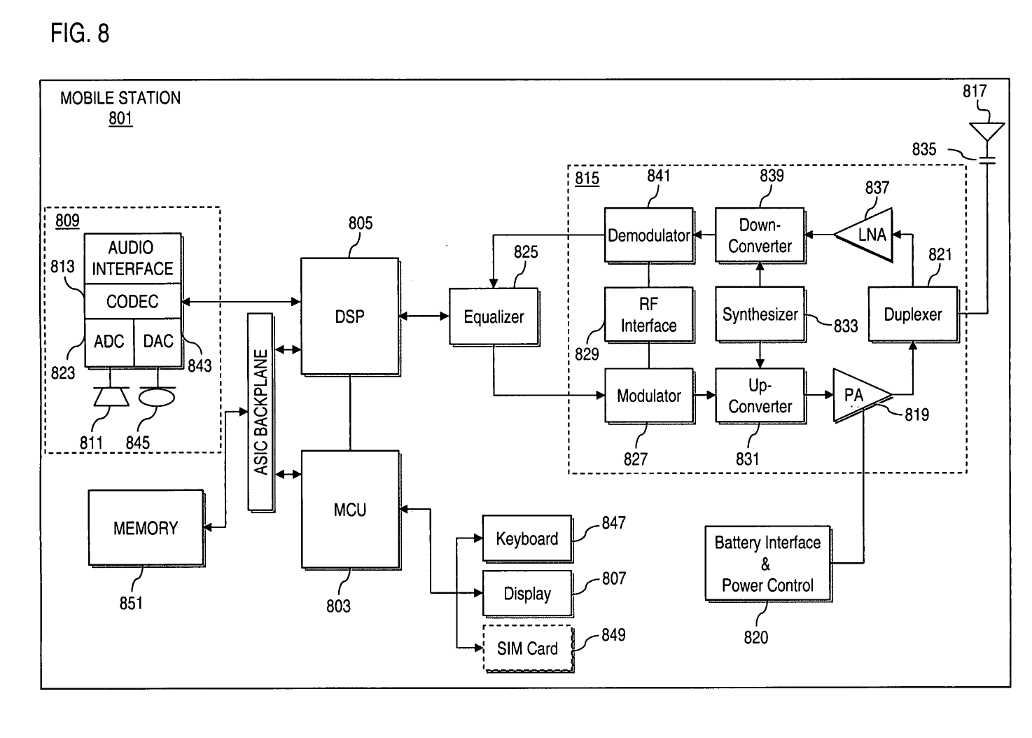

FIG. 8 is a diagram of exemplary components of a mobile station (e.g., handset) capable of operating in the systems of FIGS. 7A and 7B, according to an embodiment of the invention. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile station functions. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system (e.g., systems of FIG. 7A or 7B), via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile station 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In the exemplary embodiment, the processed voice signals are encoded, by units not separately shown, using the cellular transmission protocol of Code Division Multiple Access (CDMA), as described in detail in the Telecommunication Industry Association's TIA/EIAIS-95-A Mobile Station-Base Station Compatibility Standard for Dual-Mode Wideband Spread Spectrum Cellular System; which is incorporated herein by reference in its entirety.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 1005. A Digital to Analog Converter (DAC) 843 converts the signal and the resulting output is transmitted to the user through the speaker 845, all under control of a Main Control Unit (MCU) 803—which can be implemented as a Central Processing Unit (CPU) (not shown).

The MCU 803 receives various signals including input signals from the keyboard 847. The MCU 803 delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the station. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile station 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile station 801 on a radio network. The card 849 also contains a memory for storing a personal telephone number registry, text messages, and user specific mobile station settings.

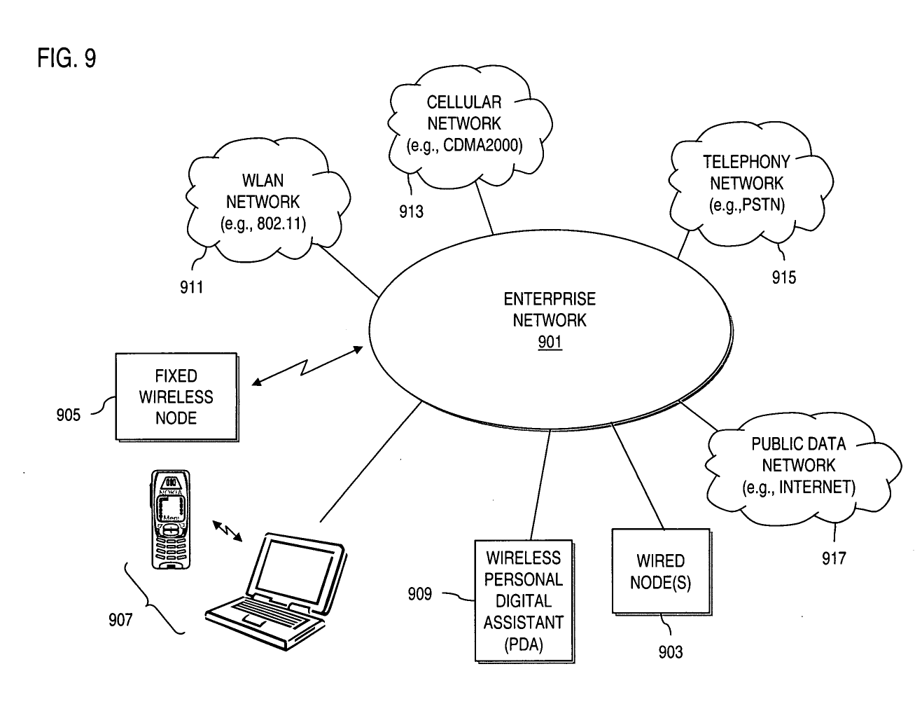

FIG. 9 shows an exemplary enterprise network, which can be any type of data communication network utilizing packet-based and/or cell-based technologies (e.g., Asynchronous Transfer Mode (ATM), Ethernet, IP-based, etc.). The enterprise network 901 provides connectivity for wired nodes 903 as well as wireless nodes 905-909 (fixed or mobile), which are each configured to perform the processes described above. The enterprise network 901 can communicate with a variety of other networks, such as a WLAN network 911 (e.g., IEEE 802.11), a cdma2000 cellular network 913, a telephony network 916 (e.g., PSTN), or a public data network 917 (e.g., Internet).

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
assigning a first rate to a first error correction channel; and
assigning a second rate to a second error correction channel, wherein the first rate is different from the second rate.

2. A method according to claim 1, wherein each of the error correction channels is a synchronous channel providing a hybrid automatic repeat request scheme.

3. A method according to claim 1, wherein the first rate corresponds to a first service level, and the second rate corresponds to a second service level.

4. A method according to claim 3, wherein the first service level supports a packetized voice application including telephony service.

5. A method according to claim 1, further comprising:
negotiating a parameter associated with the first error correction channel; and
receiving a packet over the first error correction channel according to the negotiated parameter.

6. A method according to claim 5, further comprising:
re-negotiating the parameter associated with the first error correction channel during transmission of data that is to be transmitted over the first error correction channel.

7. A method according to claim 1, further comprising:
dynamically adjusting the first rate or the second rate during transmission of transmission unit.

8. A method according to claim 7, wherein the dynamic adjustment is based on either format of the transmission unit, intended receiving terminal, or payload of the transmission unit.

9. A method according to claim 1, wherein the error correction channels are established over a multi-carrier wireless network or an Orthogonal Frequency Division Multiplexing (OFDM) network.

10. An apparatus comprising:
a processor configured to assign a first rate to a first error correction channel, and to assign a second rate to a second error correction channel,
wherein the first rate is different from the second rate.

11. An apparatus according to claim 10, wherein each of the error correction channels is a synchronous channel providing a hybrid automatic repeat request scheme.

12. An apparatus according to claim 10, wherein the first rate corresponds to a first service level, and the second rate corresponds to a second service level.

13. An apparatus according to claim 12, wherein the first service level supports a packetized voice application including telephony service.

14. An apparatus according to claim 10, wherein the processor is further configured to negotiate a parameter associated with the first error correction channel, and a packet is received over the first error correction channel according to the negotiated parameter.

15. An apparatus according to claim 14, wherein the processor is further configured to re-negotiate the parameter associated with the first error correction channel during transmission of data that is to be transmitted over the first error correction channel.

16. An apparatus according to claim 10, wherein the processor is further configured to dynamically adjust the first rate or the second rate during transmission of transmission unit.

17. An apparatus according to claim 16, wherein the dynamic adjustment is based on either format of the transmission unit, intended receiving terminal, or payload of the transmission unit.

18. An apparatus according to claim 10, wherein the error correction channels are established over a multi-carrier wireless network or an Orthogonal Frequency Division Multiplexing (OFDM) network.

19. A system comprising the apparatus of claim 10, the system further comprising:
a transceiver configured to transmit a packet to a terminal over the first error correction channel.

20. A method comprising:
transmitting a packet over a first error correction channel of a first rate; and
transmitting another packet over a second error correction channel of a second rate, wherein the first rate is different from the second rate.

21. A method according to claim 20, wherein each of the error correction channels is a synchronous channel providing a hybrid automatic repeat request scheme.

22. A method according to claim 20, wherein the first rate corresponds to a first service level, and the second rate corresponds to a second service level, and the first service level supports a packetized voice application including telephony service.

23. A method according to claim 20, further comprising:
negotiating a parameter associated with the first error correction channel;
transmitting data over the first error correction channel according to the negotiated parameter; and
re-negotiating the parameter associated with the first error correction channel during transmission of data that is to be transmitted over the first error correction channel.

24. A method according to claim 20, wherein the first rate or the second rate is dynamically adjusted during transmission of transmission unit based on either format of the transmission unit, intended receiving terminal, or payload of the transmission unit.

25. A method according to claim 20, wherein the error correction channels are established over a multi-carrier wireless network or an Orthogonal Frequency Division Multiplexing (OFDM) network.

26. An apparatus comprising:
a transceiver configured to transmit a packet over a first error correction channel of a first rate, and to transmit another packet over a second error correction channel of a second rate,
wherein the first rate is different from the second rate.

27. An apparatus according to claim 26, wherein each of the error correction channels is a synchronous channel providing a hybrid automatic repeat request scheme.

28. An apparatus according to claim 26, wherein the first rate corresponds to a first service level, and the second rate corresponds to a second service level, and the first service level supports a packetized voice application including telephony service.

29. An apparatus according to claim 26, further comprising:
a processor configured to negotiate a parameter associated with the first error correction channel, wherein the transceiver is further configured to transmit another packet over the first error correction channel according to the negotiated parameter, the processor being further configured to re-negotiate the parameter associated with the first error correction channel during transmission of data that is to be transmitted over the first error correction channel.

30. An apparatus according to claim 26, wherein the first rate or the second rate is dynamically adjusted during transmission of transmission unit based on either format of the transmission unit, intended receiving terminal, or payload of the transmission unit.

31. An apparatus according to claim 26, wherein the error correction channels are established over a multi-carrier wireless network or an Orthogonal Frequency Division Multiplexing (OFDM) network.

32. An apparatus according to claim 26, further comprising:
means for receiving user input to initiate communication over a communication network; and
a display configured to display the user input.

33. A system comprising:
a base station configured to assign different rates to a plurality of synchronous error correction channels; and
a terminal configured to transmit a packet over one of the synchronous acknowledgement channels.

34. A system according to claim 33, wherein the synchronous error correction channels are established over a multi-carrier wireless network or an Orthogonal Frequency Division Multiplexing (OFDM) network, and each of the synchronous error correction channels provides a hybrid automatic repeat request scheme.

35. A system comprising:
a terminal configured to assign different rates to a plurality of synchronous error correction channels; and
a base station configured to transmit a packet over one of the synchronous error correction channels.

36. A system according to claim 35, wherein the synchronous error correction channels are established over a multi-carrier or OFDM wireless network, and each of the synchronous error correction channels provides a hybrid automatic repeat request scheme.
